(19) United States
(12) Patent Application Publication
(10) Pub. No.: US 2024/0407295 A1
(43) Pub. Date: Dec. 12, 2024

(54) AUTOMATED FRUIT HARVESTING MACHINE

(71) Applicant: KING FAISAL UNIVERSITY, AL-Ahsa (SA)

(72) Inventors: ABDULAZIZ ELSINAWI, Al-Ahsa (SA); FERAS FADHEL BUZAID, Al-Ahsa (SA); AHMED EMAD ALMUHANA, Al-Ahsa (SA); HUSSAIN ALI AL-GHAZAL, Al-Ahsa (SA); MOHAMMED ABDULLAH AL-BHRANI, Al-Ahsa (SA); MOHAMMED JAMEEL AL-HELAL, Al-Ahsa (SA); QASEM AHMED TAHER BIN GHAYTH, Al-Ahsa (SA)

(21) Appl. No.: 18/330,213

(22) Filed: Jun. 6, 2023

(51) Int. Cl. A01D 46/253

(52) U.S. Cl. CPC A01D 46/253; A01D 46/005

(57) ABSTRACT

The automated fruit harvesting machine is used for the harvesting of fruit, such as dates or the like. The automated fruit harvesting machine includes an extensible frame and a suction vacuum. A vacuum section includes a first flexible tubing and a second flexible tubing, each having first and second ends. A storage container is provided for collecting fruit. The first end of the first flexible tubing and the first end of the second flexible tubing are each connected to the storage container. The second end of the first flexible tubing is connected to a suction funnel. The suction vacuum includes a power source, and the second end of the second flexible tubing is connected to the suction vacuum. The extensible frame section includes proximal and distal frame members which are mated together for parallel extension therebetween. The vacuum funnel is connected to the distal frame member and is extendable therewith.

### BACKGROUND

### Field

The present subject matter relates to harvesting fruit, and particularly the harvesting of fruit growing on trees, such as those of the date palm tree.

### Description of Related Art

Date harvesting has traditionally been performed manually by farmers and workers. Typically, a farmer or worker climbs a date palm tree and performs the labor of reaching for, picking, and collecting date palm fruit (i.e., dates). The primary mechanized tools thus far have involved the introduction of hydraulic elevators to lift the worker in a basket or carriage, allowing the worker to be elevated for the picking and collecting of dates from a date palm tree. This process is slow, laborious and can be very dangerous for the workers. Thus, an automated fruit harvesting machine solving the aforementioned problems is desired.

### SUMMARY

The present subject matter relates to an automated fruit harvesting machine that may be used for the harvesting of fruit, such as dates or the like. The automated fruit harvesting machine can include an extensible frame and a suction vacuum. A vacuum section can include a first flexible tubing and a second flexible tubing, each having first and second ends. A storage container can be provided for collecting fruit. The first end of the first flexible tubing and the first end of the second flexible tubing can each be connected to the storage container. The second end of the first flexible tubing can be connected to a suction or vacuum funnel. The suction vacuum includes a power source, and the second end of the second flexible tubing can be connected to the suction vacuum. The extensible frame section can include a proximal frame member and a distal frame member which are mated together for parallel extension therebetween. The vacuum funnel can be connected to the distal frame member and is extendable therewith. A tension member contacts the proximal frame member and the distal frame member for selectively extending said distal frame member.

In an embodiment, the present subject matter relates to an automated fruit harvesting machine comprising: a vacuum section comprising a first flexible tubing and a second flexible tubing, wherein each of the first and second flexible tubing has first and second ends; a storage container, wherein the first end of said first flexible tubing and the first end of said second flexible tubing are each connected to the storage container; a suction funnel, wherein the second end of said first flexible tubing is connected to the suction funnel; a suction vacuum comprising a power source, wherein the second end of said second flexible tubing is connected to the suction vacuum; an extensible frame section comprising a proximal frame member and a distal frame member; and means for mating said proximal and distal frame members together for parallel extension therebetween, wherein said vacuum funnel is connected to said distal frame member and is extendable therewith.

In another embodiment, the present subject matter relates to an automated fruit harvesting machine comprising: a vacuum section comprising a first flexible tubing and a second flexible tubing, wherein each of the first and second flexible tubing has first and second ends; a storage container, wherein the first end of said first flexible tubing and the first end of said second flexible tubing are each connected to the storage container; a suction funnel, wherein the second end of said first flexible tubing is connected to the suction funnel; a suction vacuum comprising a power source, wherein the second end of said second flexible tubing is connected to the suction vacuum; an extensible frame section comprising a proximal frame member and a distal frame member; means for mating said proximal and distal frame members together for parallel extension therebetween, wherein said vacuum funnel is connected to said distal frame member and is extendable therewith; and a tension member contacting said proximal frame member and said distal frame member for selectively extending said distal frame member.

These and other features of the presently disclosed subject matter will become more apparent upon review of the following description and appended claims with reference to the accompanying drawings.

### BRIEF DESCRIPTION OF THE DRAWINGS

FIG. 1 is a perspective view of one embodiment of the automated fruit harvesting machine, shown in an extended state.

FIG. 2 is a perspective view of an alternative embodiment of the automated fruit harvesting machine, shown in an extended state.

FIG. 3 is a perspective view showing the automated fruit harvesting machine of FIG. 1 in a retracted state.

FIG. 4 is a perspective view of a collection container of the automated fruit harvesting machine.

FIG. 5 is a perspective view of the automated fruit harvesting machine of FIG. 1, shown in an extended state.

Similar reference character numbers denote corresponding features consistently throughout the drawings.

### DETAILED DESCRIPTION

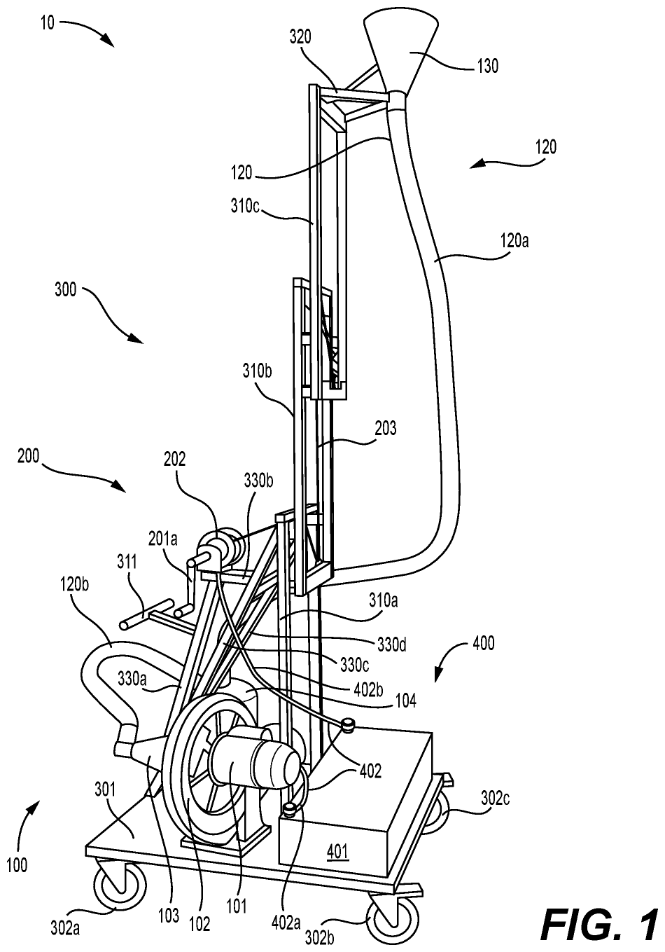

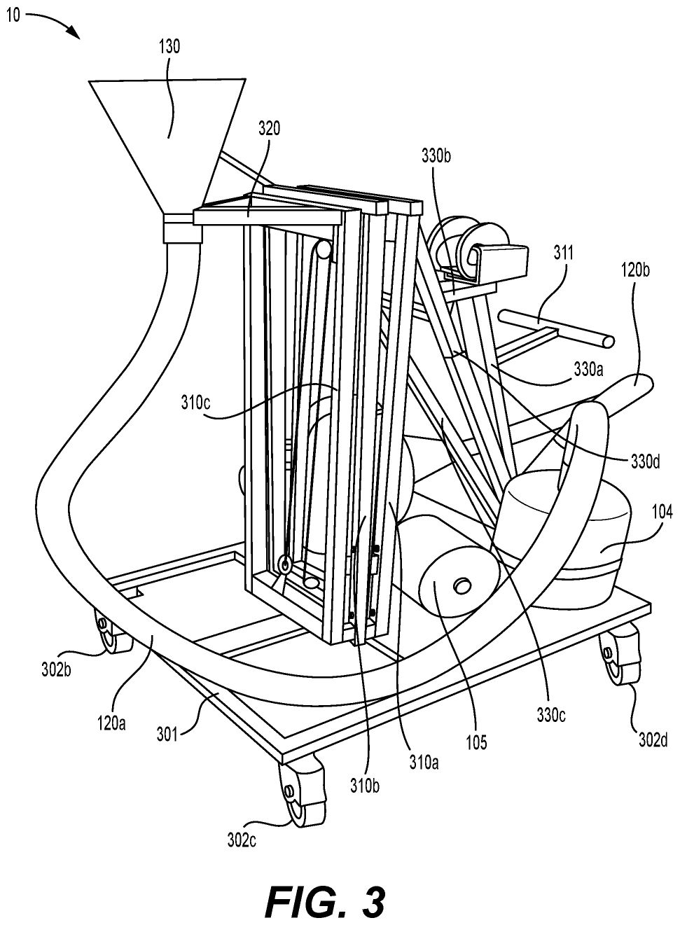

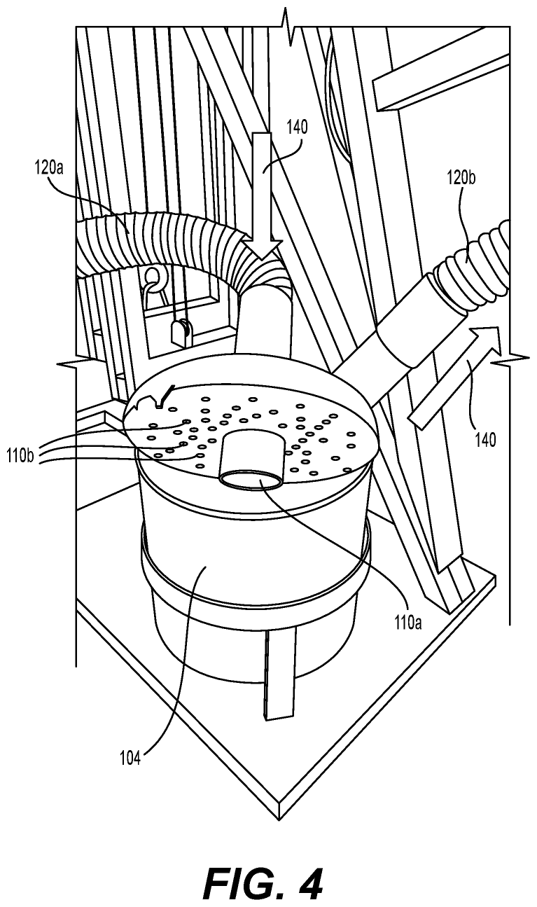

FIG. 1 shows the automated fruit harvesting machine 10. In the embodiment of FIG. 1, automated fruit harvesting machine 10 may include a vacuum section 100, a winch section 200, a frame section 300, and a power section 400. Vacuum section 100 of harvesting machine 10 may include vacuum funnel 130 used to collect fruit growing on a tree. As a non-limiting example, funnel 130 may be used to collect date palm fruit hanging on a date palm tree. It should be understood that funnel 130 is shown in FIG. 1 for exemplary purposes only and may have any suitable shape and relative dimensions. Funnel 130 is connected to first flexible tubing section 120a, which connects funnel 130 to a collection container 104 used for storing the collected fruit (best seen in FIG. 4). A second section of flexible tubing 120b connects container 104 to a suction funnel 103. Suction funnel 103 channels intake air to an impeller 102 which is rotated by vacuum motor 101. A diffuser 105, shown in FIG. 3, is connected to impeller 102 and motor 101 to reduce air velocity and muffle the amount of noise generated. It should be understood that suction funnel 103 is shown in FIG. 1 for exemplary purposes only and may have any suitable shape and relative dimensions. Additionally, it should be understood that motor 101, diffuser 105 and impeller 102 are each shown for exemplary purposes only, and that any suitable type of motor (or similar drive), diffuser or the like, and impeller or the like may be used.

In addition to vacuum section 100, automated fruit harvesting machine 10 contains a winch section 200 and a frame section 300. As shown in FIG. 1, frame section 300 includes extensible frame members 310a, 310b, 310c, which are coupled to one another in an extendible manner. Frame section 300 further includes means for mating members 310a, 310b, 310c in extendable, parallel relation to one another. By way of non-limiting example, such means for mating can include one or more male insertion members and corresponding female reception slots. Although only three frame members are shown in the drawings, it is conceivable that only two extendable frame members may be used, as well as three or more frame members. It should be further understood that extensible frame members 310a, 310b and 310c may be extendibly connected to one another using any type of adjustable connection or coupling.

FIG. 1 shows the distal frame member 310c in an extended position away from proximal frame member 310a. Suction funnel 130 is connected to distal frame member 310c through mounting 320 and extends and retracts simultaneously with frame member 310c. In the extended position, funnel 130 may be used to collect fruit through tubing 120a and into collection container 104 for storage. It should be understood that extensible frame members 310a, 310b, 310c are shown in FIG. 1 for exemplary purposes only and may have any suitable shapes and relative dimensions. Further, it should be understood that mounting 320 is shown for exemplary purposes only and may also have any suitable shape and relative dimensions.

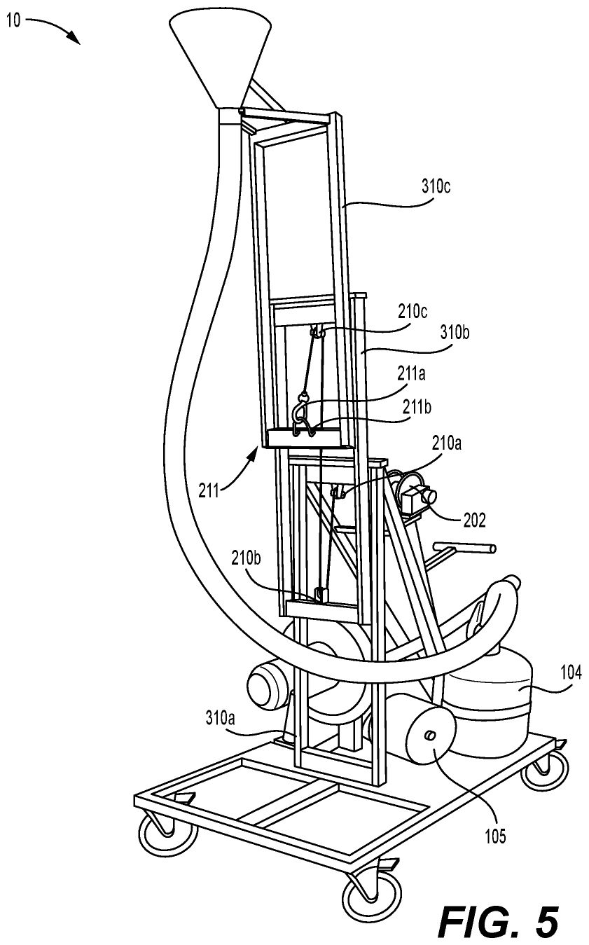

Winch section 200 may be used to provide the tensile force to extend and retract frame members 310a, 310b, 310c. As shown in FIG. 1, winch section 200 may include a crank 201a, spool 202 and a tension member 203, such as a wire, cable, rope, or the like. Tension member 203 is in contact with frame members 310a, 310b, 310c through, for example, pulleys 210a, 210b, 210c (shown in FIG. 5), as well as end fastener 211, which may be, as a non-limiting example, a hook 211a and eyelet 211b. When a tensile force is applied to tension member 203 through the winding of crank 201a, an upward force is translated and applied to frame members 310a, 310b, 310c through the placement of pulleys 210a, 210b, 210c and fastener 211, thus causing the parallel extension of the frame members and the suction funnel 130 to an extended position suitable for collecting fruit.

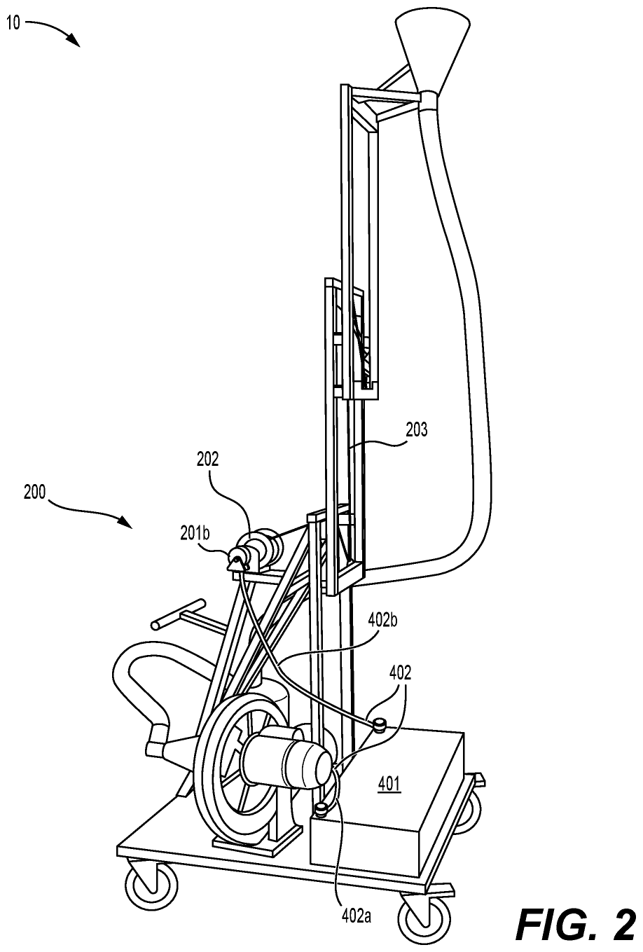

FIG. 2 shows an alternative embodiment of automated fruit harvesting machine 10 similar to that described above, but with winch section 200 powered by a motor 201b. Winch motor 201b and vacuum motor 101 may be powered by a power source 401. Connections 402a and 402b are provided to connect power source 401 to vacuum motor 101 and winch motor 201b, respectively. Power source 401 may be, by way of non-limiting example, a battery such as a lithium-ion battery, or a generator, such as a diesel fuel generator. It should be understood that motor 201b may be any suitable type of motor, rotational actuator or the like to impart rotational drive to the winch.

FIG. 3 shows the automated fruit harvesting machine 10 in a retracted position. As shown, a diffuser 105 or the like may be connected to impeller 102 to muffle the suction noise. One or more support struts 330a, 330b, 330c, 330d may be provided between the extendable frame members 310a, 310b, 310c and a base frame member 301. Base frame member 301 may be fitted with wheels 302a, 302b, 302c, 302d for mobility. Four support strut members 330a, 330b, 330c, 330d are shown for structural support of extensible frame members 310. Support strut members 330c, 330d are shown in connection between proximal frame member 310a and frame base 301. Strut member 330a is shown in connection between frame base 301 and support strut 330b. Support strut 330b is shown in connection with support strut 330a and having winch spool 202 mounted thereon. It should be understood that any arrangement or configuration of support struts may be used to provide support for the extensible frame members. Optionally, a push handle 311 (shown in FIG. 1) may be included and mounted to support strut 330a for providing mobility of the machine 10.

FIG. 4 is an enlarged view of the collection container 104. An opening 110a formed through the lid of collection container 104 may be provided for the intake of fruit gathered by suction funnel 130 through tubing 120a and into container 104. Small holes 110b provide suction to container 104 and may be sized to allow the egress of air and particles smaller than a date palm fruit from container 104 through flexible tubing section 120b. Arrows 140 indicate the direction of air suction flowing through flexible tubing 120.

As noted above, FIG. 5 better illustrates the placement of pulleys 210a, 210b, 210c and end fastener 211. Appropriate placement of pulleys 210 and fastener 211 on the upper and lower ends of frame members 310 allows for the tensile force to be translated into an upward force acting on the frame members, thus urging the frame members into the extended position shown. It should be understood that the size, shape and placement of pulleys 210a, 210b, 210c and end fastener 211 are shown for exemplary purposes only.

It is to be understood that the automated fruit harvesting machine is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An automated fruit harvesting machine comprising:
a vacuum section comprising a first flexible tubing and a second flexible tubing, wherein each of the first and second flexible tubing has first and second ends;
a storage container having a lid with a plurality of holes, wherein the first end of said first flexible tubing and the first end of said second flexible tubing are each connected to the storage container and wherein the plurality of holes are configured to keep harvested fruit from said second flexible tubing;
a suction funnel, wherein the second end of said first flexible tubing is connected to the suction funnel;
a suction vacuum comprising a power source, wherein the second end of said second flexible tubing is connected to the suction vacuum;
an extensible frame section comprising a proximal frame member and a distal frame member;
a base frame, said vacuum section and extensible frame section being mounted thereon:
a support strut mounted between said extensible frame section and said base frame;
one or more wheels connected to the base frame;
a push handle mounted to said support strut for providing mobility to said machine; and
means for mating said proximal and distal frame members together for parallel extension therebetween, wherein said suction funnel is connected to said distal frame member and is extendable therewith.

2. The automated fruit harvesting machine according to claim 1, further comprising a tension member contacting said proximal frame member and said distal frame member for selectively extending said distal frame member.

3. The automated fruit harvesting machine according to claim 2, further comprising a winch coupled to said tension member.

4. The automated fruit harvesting machine according to claim 2, wherein contact between said tension member and said proximal and distal frame members is provided by one or more pulleys and an end fastener.

5. The automated fruit harvesting machine according to claim 1, wherein said suction vacuum further comprises a motor, an impeller, and a diffuser.

6-8. (canceled)

9. The automated fruit harvesting machine according to claim 1, wherein said power source comprises at least one of a lithium-ion battery and a diesel-powered generator.

10. An automated fruit harvesting machine comprising:
a vacuum section comprising a first flexible tubing and a second flexible tubing, wherein each of the first and second flexible tubing has first and second ends;
a storage container having a lid with a plurality of holes, wherein the first end of said first flexible tubing and the first end of said second flexible tubing are each connected to the storage container and wherein the plurality of holes are configured to keep harvested fruit from said second flexible tubing;
a suction funnel, wherein the second end of said first flexible tubing is connected to the suction funnel;
a suction vacuum comprising a power source, wherein the second end of said second flexible tubing is connected to the suction vacuum;
an extensible frame section comprising a proximal frame member and a distal frame member;
a base frame, said vacuum section and extensible frame section being mounted thereon;
a support strut mounted between said extensible frame section and said base frame;
one or more wheels connected to the base frame;
a push handle mounted to said support strut for providing mobility to said machine;
means for mating said proximal and distal frame members together for parallel extension therebetween, wherein said suction funnel is connected to said distal frame member and is extendable therewith; and
a tension member contacting said proximal frame member and said distal frame member for selectively extending said distal frame member.

11. The automated fruit harvesting machine according to claim 10, further comprising a winch coupled to said tension member.

12. The automated fruit harvesting machine according to claim 11, wherein said winch further comprises a motor in communication with said power source.

13-15. (canceled)

16. The automated fruit harvesting machine according to claim 10, wherein said suction vacuum further comprises an impeller, a motor, and a diffuser.
